(19) United States
(12) Patent Application Publication
(10) Pub. No.: US 2024/0217072 A1
(43) Pub. Date: Jul. 4, 2024

(54) RATCHET RING

(71) Applicants: Yi-Fu Chen, TAICHUNG CITY (TW); He-Qian Chen, TAICHUNG CITY (TW)

(72) Inventors: Yi-Fu Chen, TAICHUNG CITY (TW); He-Qian Chen, TAICHUNG CITY (TW)

(21) Appl. No.: 18/092,946

(22) Filed: Jan. 4, 2023

(51) Int. Cl. B25B 13/46

(52) U.S. Cl. CPC B25B 13/463

(57) ABSTRACT

A ratchet ring includes six first driving portions formed to the inner periphery of the ratchet ring. Each first driving portion includes a first driving face and a toothed face. A second driving portion is formed in each of the six first driving portions and includes two second driving faces which respectively extend from the first driving face and the toothed face. A first angle is formed between the two second driving faces. A third driving portion is formed in each of the six first driving portions and includes a recess located between the two second driving faces. A second angle is formed between two sides of the recess. A step is formed between the two second driving faces and the third driving portion. When a corner of an object is engaged between the two second driving faces, the step avoids the object from dropping from the ratchet ring.

### BACKGROUND OF THE INVENTION

### 1. Fields of the Invention

The present invention relates to a ratchet ring, and more particularly, to a ratchet ring for easily tightening or loosening a bolt or the like.

### 2. Descriptions of Related Art

The conventional ratchet tools can only driving a single-size nuts or bolt. However, for complex mechanisms for example, there are bolts or nuts of different sizes so that the users have to change different tools for these bolts or nuts. In addition, if the above-mentioned machinery needs to be inspected and maintained frequently, the nuts/bolts are rotated repeatedly, which may easily cause the bolts or nuts to be worn or damaged, so that the conventional ratchet tools may not properly hold the worn or damaged bolts or nuts. Therefore, it will take a lot of time to deal with the worn or damaged bolts or nut which is not efficient.

The present invention intends to provide a ratchet ring to eliminate the shortcomings mentioned above.

### SUMMARY OF THE INVENTION

The present invention relates to a ratchet ring and comprises a first face and a second face which is located opposite to the first face. Multiple ratchet teeth are formed to the outer periphery of the ratchet ring. Six first driving portions are formed to the inner periphery of the ratchet ring. Each first driving portion includes a first driving face and a toothed face. The first driving face communicates through the first and second faces. The toothed face includes multiple teeth. A second driving portion is formed in each of the six first driving portions and includes two second driving faces which respectively extend from the first driving face and the toothed face. A first angle is formed between the two second driving faces. A third driving portion is formed in each of the six first driving portions and includes a recess which communicates through the second face of the ratchet ring. The recess is located between the two second driving faces. A second angle is formed between two sides of the recess. A radial depth of the first angle is greater than the radial depth of the second angle so as to form a step between the two second driving faces and the third driving portion. The two second driving faces each have the first end thereof communicating through the first face of the ratchet ring, and the second end of each second driving face is ended at the step. When at least one corner of an object is engaged between the two second driving faces, the step contacts one of two ends of the object to avoid the object from dropping from the second face of the ratchet ring.

When the ratchet ring is mounted to an object, the first and second driving faces contact multiple sides of the object, and the step contacts one of two ends of the object to avoid the object from dropping from the second face of the ratchet ring. When the first driving faces drive the object, the toothed faces contact the sides of the object to rotate the object. Even the object is worn, the ratchet ring of the present invention is able to rotate the object. The third driving portion is mounted to and rotates an object of smaller size.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the ratchet ring of the present invention;

FIG. 2 is another perspective view to show the ratchet ring of the present invention;

FIG. 3 is a perspective view to show that the ratchet ring is mounted to an object with the first driving faces contacting the object;

FIG. 4 is a top view of the disclosure in FIG. 3;

FIG. 5 is a perspective view to show that the ratchet ring is mounted to an object with the second driving faces contacting the object;

FIG. 6 is a top view of the disclosure in FIG. 5;

FIG. 7 is a perspective view to show that the ratchet ring is mounted to an object with the third driving portion contacting the object;

FIG. 8 is a top view of the disclosure in FIG. 7;

FIG. 9 shows another embodiment of the third driving portion of the ratchet ring of the present invention;

FIG. 10 shows that the ratchet ring is to be inclinedly mounted to an object;

FIG. 11 shows yet another embodiment of the ratchet ring, wherein each first driving portion includes two toothed faces, and

FIG. 12 is a top view of the disclosure in FIG. 11.

### DETAILED DESCRIPTION OF THE PREFERRED EMBODIMENT

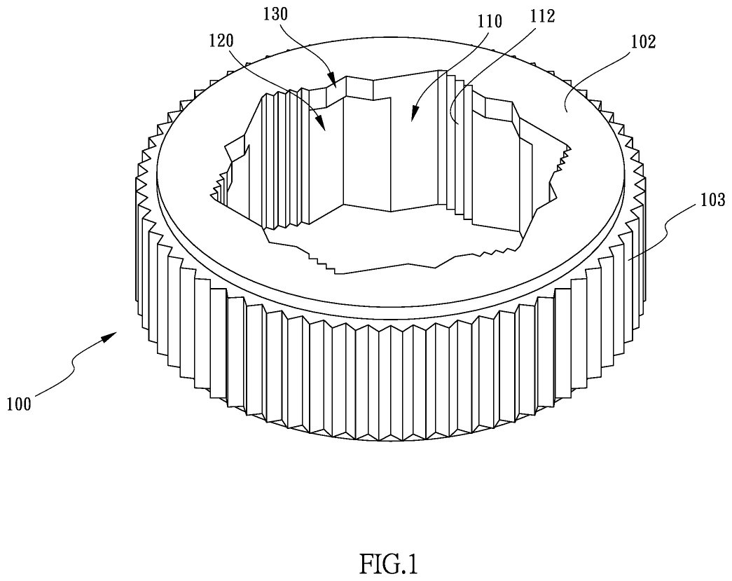

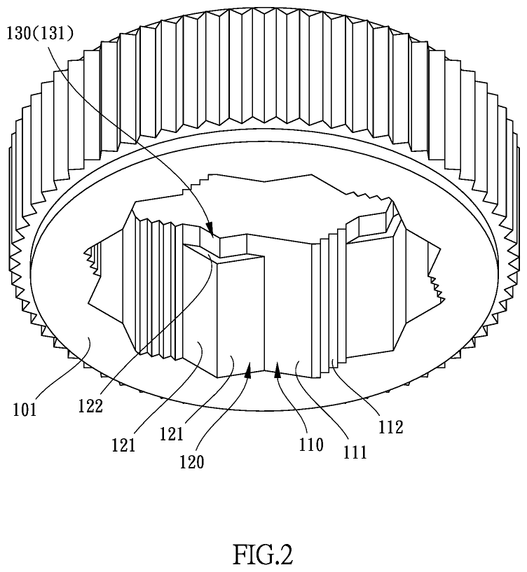

Referring to FIGS. 1 to 8, the ratchet ring 100 of the present invention comprises a first face 101 and a second face 102 which is located opposite to the first face 101. Multiple ratchet teeth 103 are formed to the outer periphery of the ratchet ring 100. The ratchet ring 100 is connected to a ratchet wrench and controlled by the ratchet mechanism of the ratchet wrench.

Six first driving portions 110 are formed to the inner periphery of the ratchet ring 100. Each first driving portion 110 includes a first driving face 111 and a toothed face 112. The first driving face 111 communicates through the first and second faces 101, 102. The toothed face 112 includes multiple teeth, and the teeth of the toothed face 112 of each first driving portion 110 extend axially and communicate through the first and second faces 101, 102.

A second driving portion 120 is formed in each of the six first driving portions 110 and includes two second driving faces 121 which respectively extend from the first driving face 111 and the toothed face 112. A first angle is formed between the two second driving faces 121. The toothed face 112 of each first driving portion 110 is located beside one of two sides of the second driving portion 120 as shown in FIG. 1.

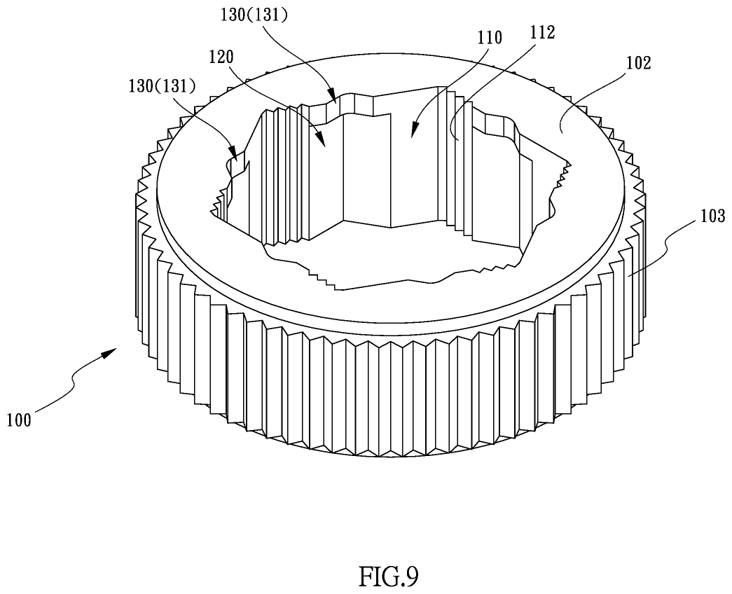

A third driving portion 130 is formed in each of the six first driving portions 110 and includes a recess 131 which communicates through the second face 102 of the ratchet ring 100. The recess 131 is located between the two second driving faces 121. The recess 131 is an obtuse angle as shown in FIG. 1, or a circular recess as shown in FIG. 9. A second angle is formed between two sides of the recess 131. The radial depth of the first angle is greater than a radial depth of the second angle so as to form a step 122 between the two second driving faces 121 and the third driving portion 130. As shown in FIGS. 1-4, the step 122 protrudes inward and radially from the two second driving faces 121.

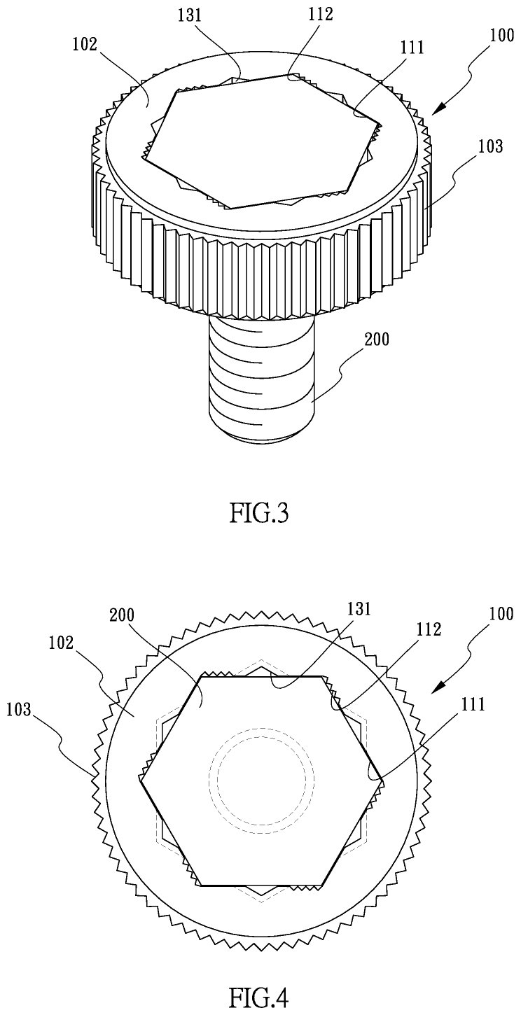

The two second driving faces 121 each have the first end thereof communicating through the first face 101 of the ratchet ring 100, and the second end of each second driving face 121 is ended at the step 122. As shown in FIGS. 3 and 4, the ratchet ring 100 is mounted to an object 200, and both of the first driving faces 111 and the toothed faces 112 contact the six sides of the object 200, so that the object 200 is well positioned in the ratchet ring 100 and can be rotated when the ratchet ring 100 is rotated. The toothed faces 112 can effectively drive a worn object.

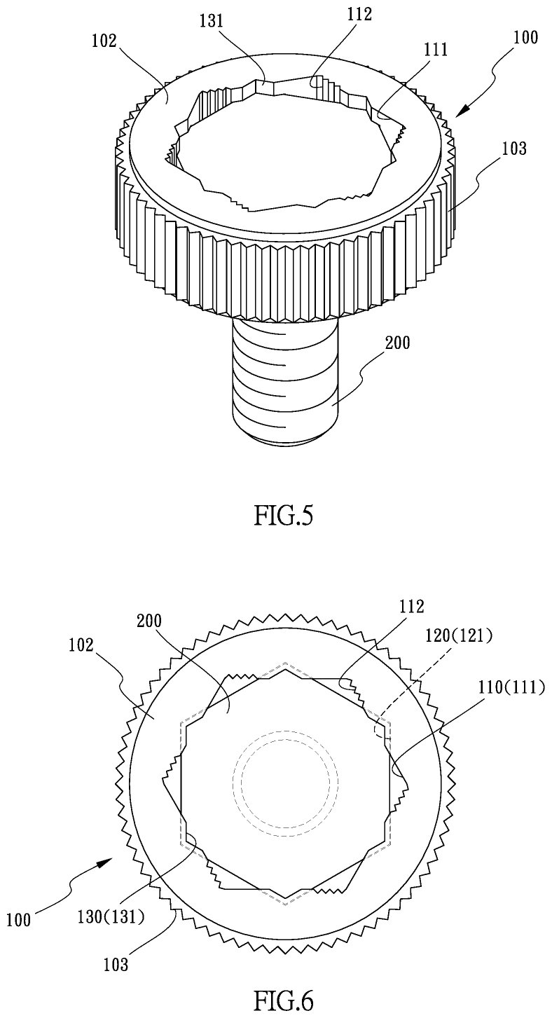

As shown in FIGS. 5 and 6, when the ratchet ring 100 is mounted to the object 200 from the first face 101 of the ratchet ring 100, at least one corner of the object 200 is engaged between the two second driving faces 121. The step 122 contacts one of two ends of the object 200 to avoid the object 200 from dropping from the second face 102 of the ratchet ring 100.

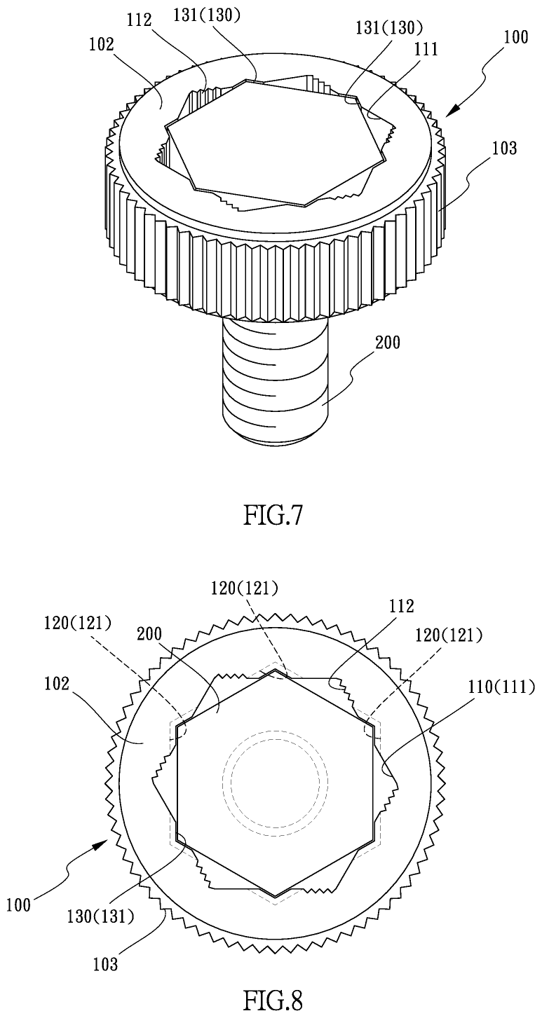

As shown in FIGS. 7 and 8, when the ratchet ring 100 is mounted to a smaller object 200 and the six corners of the object 200 are engaged with the recesses 131. Therefore, the object 200 can also be rotated.

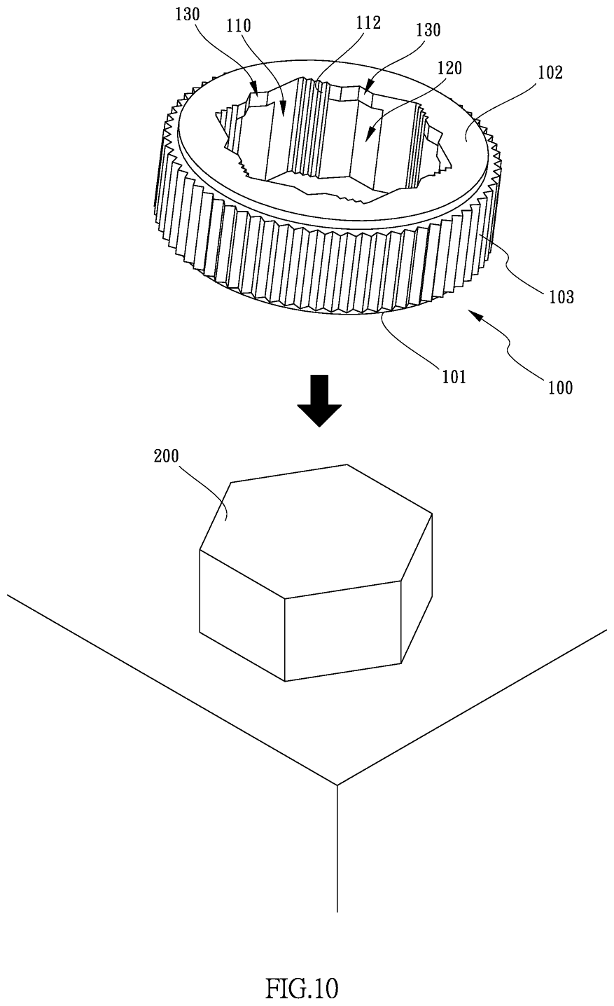

The recess 131 is an obtuse angle as shown in FIG. 1 so as to drive a normal object 200. The recess 131 is a circular recess as shown in FIG. 9 is able to rotate a smaller object 200 or a smaller worn object 200. The ratchet ring 100 is able to be inclinedly mounted to a smaller object 200 as shown in FIG. 10.

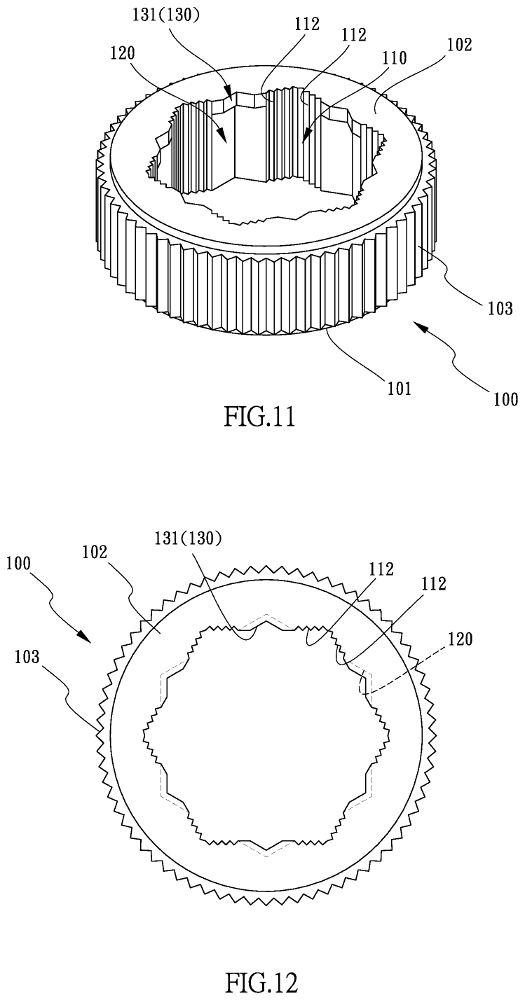

As shown in FIGS. 11 and 12, another embodiment of the ratchet ring 100 is shown, wherein the difference from the first embodiment, is that each first driving portion 110 does not have the first driving face 111, instead, each first driving portion 110 includes two toothed faces 112. The two toothed faces 112 communicate through the first and second faces 101, 102 of the ratchet ring 100.

While we have shown and described the embodiment in accordance with the present invention, it should be clear to those skilled in the art that further embodiments may be made without departing from the scope of the present invention.

What is claimed is:

1. A ratchet ring comprising:
a first face and a second face which is located opposite to the first face, multiple ratchet teeth formed to an outer periphery of the ratchet ring;
six first driving portions formed to an inner periphery of the ratchet ring, each first driving portion including a first driving face and a toothed face, the first driving face communicating through the first and second faces, the toothed face including multiple teeth;
a second driving portion formed in each of the six first driving portions and including two second driving faces which respectively extending from the first driving face and the toothed face, a first angle formed between the two second driving faces;
a third driving portion formed in each of the six first driving portions and including a recess which communicates through the second face of the ratchet ring, the recess located between the two second driving faces, a second angle formed between two sides of the recess, a radial depth of the first angle being greater than a radial depth of the second angle so as to form a step between the two second driving faces and the third driving portion, and
the two second driving faces each having a first end thereof communicating through the first face of the ratchet ring, a second end of each second driving face being ended at the step, when at least one corner of an object is engaged between the two second driving faces, the step contacts one of two ends of the object to avoid the object from dropping from the second face of the ratchet ring.

2. The ratchet ring as claimed in claim 1, wherein the teeth of the toothed face of each first driving portion extend axially and communicate through the first and second faces.

3. The ratchet ring as claimed in claim 1, wherein the toothed face of each first driving portion is located beside one of two sides of the second driving portion.

4. The ratchet ring as claimed in claim 1, wherein the recess is an obtuse angle.

5. The ratchet ring as claimed in claim 1, wherein the recess is a circular recess.

6. A ratchet ring comprising:
a first face and a second face which is located opposite to the first face, multiple ratchet teeth formed to an outer periphery of the ratchet ring;
six first driving portions formed to an inner periphery of the ratchet ring, each first driving portion including two toothed faces, the two toothed faces communicating through the first and second faces, the toothed face including multiple teeth;
a second driving portion formed in each of the six first driving portions and including two driving faces which respectively extending from the two toothed faces, a first angle formed between the two driving faces;
a third driving portion formed in each of the six first driving portions and including a recess which communicates through the second face of the ratchet ring, the recess located between the two driving faces, a second angle formed between two sides of the recess, a radial depth of the first angle being greater than a radial depth of the second angle so as to form a step between the two driving faces and the third driving portion, and
the two driving faces each having a first end thereof communicating through the first face of the ratchet ring, a second end of each second driving face being ended at the step, when at least one corner of an object is engaged between the two driving faces, the step contacts one of two ends of the object to avoid the object from dropping from the second face of the ratchet ring.

7. The ratchet ring as claimed in claim 6, wherein the two driving faces are located between the two toothed faces.

8. The ratchet ring as claimed in claim 6, wherein the teeth of the toothed face of each first driving portion extend axially and communicate through the first and second faces.

9. The ratchet ring as claimed in claim 6, wherein the recess is an obtuse angle.

10. The ratchet ring as claimed in claim 6, wherein the recess is a circular recess.
